(19) United States
(12) Patent Application Publication
(10) Pub. No.: US 2017/0288287 A1
(43) Pub. Date: Oct. 5, 2017

(54) Rechargeable aluminum-air electrochemical cell

(71) Applicant: Albufera Energy Storage, S.L., Madrid (ES)

(72) Inventors: Mikel Pino Martinez, Madrid (ES); Paloma Rodriguez Soler, Madrid (ES); Joaquin Jose Chacon Guadalix, Madrid (ES)

(21) Appl. No.: 15/479,437

(22) Filed: Apr. 5, 2017

(30) Foreign Application Priority Data
Apr. 5, 2016 (ES) P201630411

(51) Int. Cl. H01M 12/08; H01M 4/38; H01M 4/90

(52) U.S. Cl. CPC H01M 12/08; H01M 4/9016; H01M 4/9083; H01M 4/38; H01M 2300/0045; H01M 2300/0028

(57) ABSTRACT

The present invention relates to a secondary aluminum-air electrochemical cell. Therefore, the invention may be framed within the energy storage sector and, in particular, the sector of technologies and industries that require energy accumulators.

The present invention is referred to a secondary aluminum-air electrochemical cell. Therefore, the invention may be framed within the energy storage sector and, in particular, the sector of technologies and industries that require energy accumulators.

### PRIOR ART

The present invention is based on the phenomenon discovered in the early 19th century by Georges Leclanché, who used carbon as the active material for the cathode of the Leclanché battery. He observed that the oxygen adsorbed onto the carbon was reduced thanks to the catalytic action of manganese oxide. This discovery led to the research field on the use of oxygen as a free, inexhaustible reagent. Thereafter, fuel cells started to be developed thanks to William R. Grove and his publication “On the Gas Voltaic Battery”, and to various scientists who conducted research on metal-air batteries.

Cells and metal-air batteries were back then already described as the “batteries of the future”, because it was no longer necessary to store the cathodic reagents, and the only limitation of the battery was the metal used at the anode. Since then, a large number of scientific publications and patents related to metal-air batteries have been presented and registered. Metals such as zinc [M. Xu, D. G. Ivey, Z. Xie, W. Qu, Journal of Power Sources 283 (2015) 358-371], the classic anode in a large number of primary batteries, magnesium [Y. Gofer, O. Chusid, D. Aurbach, Encyclopedia of Electrochemical Power Sources (2009) 285-301], aluminum [M. Mokhtar, M. Z. M. Talib, E. H. Majlan, S. M. Tasirin, W. M. F. W. Ramli, W. R. W. Daud, J. Sahari, Journal of Industrial and Engineering Chemistry 32 (2015) 1-20; D. R. Egan, C. Ponce de Leon, R. J. J. Wood, R. L. Jones, K. R. Stokes, F. F. Walsh, J. Power Sources 236 (2013) 293-310] and lithium [H. Cheng, K. Scott, Rechargeable Lithium Batteries (2015) 41-71], in the most recent years, have been widely studied. Much of this research focuses on primary, or non-electrically rechargeable, batteries, and developments such as the zinc-air battery or the magnesium-silver nitrate battery have become commercialised and established in the market for specific applications.

In regards to the rechargeability of these electrochemical pairs, a large number of patents have been filed related to zinc or lithium, but currently none of these developments have been commercialised, nor are expected to be industrially produced.

Aluminum and air have been widely studied by various research groups worldwide and a number of companies, such as Alupower or Alcan, have filed a large number of patents for the optimal compositions of aluminum alloys as anodes or additives for the electrolyte. All these patents were based on the aluminum-air battery with an aqueous electrolyte.

An aluminum-air battery, or Al-air battery, comprises an aluminum anode that reacts with the oxygen in the air and a cathode that is immersed in an aqueous electrolyte. Such battery produces electricity (1.5 V when the electrolyte is alkaline) from the following half-reactions [M. Pino, J. Chacón, E. Fatás, P. Ocón, Journal of Power Sources 299 (2015) 195-201]:
oxidation half-reaction at the anode is Al+3OH-→Al(OH)₃+3e−[−2.31 V]
reduction half-reaction at the cathode is O₂+2H₂O+4e−→>4OH—[+0.40 V]

the overall reaction being: 4Al+3O₂+6H₂O→4Al(OH)₃ [+2.71 V]

Aluminum-air batteries are primary cells, i.e. non-rechargeable. Once the aluminum anode is consumed, the battery ceases to produce electricity. Rechargeability in aqueous media becomes very complicated, because the aluminum reduction potential is higher than the water decomposition potential (±1.2 V). For this reason, when a current is applied in order to reduce the aluminum ions present in the aqueous electrolyte after the battery has been discharged, the water decomposes into O₂ and H₂, without achieving the reduction of the Al³⁺ ion back to its metallic state.

The rechargeability of aluminum cells has been widely studied and there are two pathways that have provided the most satisfactory results: the first is the use of organic solvents with precursor salts for aluminum deposition, such as aluminum chloride or aluminum fluoride [S. Licht, R. Tel-Vered, G. Levitin, C. Yarnitzky, Journal of The Electrochemical Society 147 (2000) 496-501]. The main problem with these solvents is their high volatility, as well as its high corrosion rate that they generate on carbonaceous materials, for which reason the air cathode does not seem to operate correctly. The second pathway, which is even more recent, is the use of ionic liquids for aluminum electrodeposition [O. B. Babushkina, E. Lomako, J. Wehr, O. Rohr, Molten Salts Chemistry and Technology (2014) 339-349] and has offered very promising results. The disadvantage of these ionic liquids is their high viscosity at room temperature and the influence of the working temperature on their performance.

Therefore, it is necessary to develop aluminum-air electrochemical cells that can satisfactorily respond to charge and discharge cycles.

### DESCRIPTION OF THE INVENTION

The present invention relates to a secondary aluminum-air electrochemical cell, i.e. the present invention relates to a rechargeable or reversible electrochemical cell or battery. The cell comprises aluminum as the negative electrode, which faces two positive electrodes that form the cathode. The anode and the cathode are electrically connected by a non-aqueous electrolyte composed of an ionic liquid and an organic solvent. In order to prevent short circuits due to contact between the electrodes, polymer separation membranes are used with a pore size that allows for mobility of the Al⁺³ ions towards the cathode.

The set of elements is wrapped with a micro-perforated housing in order to allow the entry of oxygen during discharge of the battery and for the exit of oxygen during charge, according to the reactions:
cathode half-reaction during discharge or oxygen reduction reaction:

O₂+2e⁻→2O*⁻
cathode half-reaction during charge or formation of oxygen (known as oxygen evolution reaction):

2O*⁻→O₂+2e⁻

These micro-perforations are about 1 to 10 μm, preferably between 1 and 5 μm, in order to prevent the exit of the electrolyte or the entry of moisture, whilst allowing the entry and the exit of oxygen to and from the electrodes. These perforations are sufficiently small such that, thanks to the surface tension of water, the latter is not able to enter. Moreover, since it is composed of large-sized molecules, the electrolyte cannot physically escape from the housing.

In the electrochemical cell of the present invention, the following half-reaction is produced during discharge:
at the anode: the aluminum oxidation half-reaction, to produce aluminum ions

(Al⁺³) Al+3e⁻→Al³⁺
at the cathode: the oxygen reduction half-reaction, to produce superoxides according to the reaction:

O₂+2e⁻→2O*⁻

The overall reaction being:

Al+O₂→AlO₂^{*-}

During recharge, the opposite process takes place, such that the original species are regenerated, and the aluminum superoxide breaks down, to cause the reduction into metallic aluminum (Al⁰) at the anode and the formation of oxygen at the cathodes.

The Al-air battery of the present invention has a cyclability greater than 200 cycles, maintaining a coulombic efficiency of 75%, with an initial cell potential higher than 2 volts during the first charge and discharge cycles, due to the formation of a solid electrolyte interphase at the positive electrode, which consists of a solid interphase of electrolytes absorbed by the gas diffusion layer. Subsequently, the cell potential becomes stabilised at about 1.5 V.

Therefore, a first aspect of the present invention relates to a secondary aluminum-air electrochemical cell characterised in that it comprises:
a first positive electrode and a second positive electrode electrically connected to one another to form the cathode;
a negative electrode that forms the anode, placed between the first positive electrode and the second positive electrode;
a first separation membrane placed between the first positive electrode and the negative electrode;
a second separation membrane placed between the second positive electrode and the negative electrode;
a non-aqueous electrolyte that covers the first positive electrode, the second positive electrode, the negative electrode, the first separation membrane and the second separation membrane;
a housing that comprises the first positive electrode, the second positive electrode, the negative electrode, the first separation membrane, the second separation membrane and the electrolyte;

where each positive electrode comprises:
a metal mesh that confers stability upon the positive electrode, which is responsible for collecting the electrons originating from the anode during discharge and responsible for directing the electrons towards the anode during charge;
a gas diffusion layer, pressed into the metal mesh, which is selected from a pyrolytic graphite sheet or a non-woven carbon fabric;
and a catalytic ink dispersed on the gas diffusion layer, wherein the catalytic ink comprises:
   a catalyst that comprises at least one metal oxide selected from ruthenium oxide RuO₂, manganese oxide MnO₂, iridium oxide IrO₂, nickel oxide Ni₂O₃ and lanthanum oxide La₂O₃;
   a support for the catalyst based on reduced graphene oxide;
   and an alcoholic solution;

where each separation membrane has a pore size ranging between 60 and 90 pm,

which allows for passage of the Al⁺³ ions;

where the negative electrode comprises aluminum.

In the secondary electrochemical cell of the present invention, each positive electrode comprises:
a metal mesh that confers stability upon the positive electrode, which is responsible for collecting the electrons originating from the anode during discharge and responsible for directing the electrons towards the anode during charge;
a gas diffusion layer, pressed into the metal mesh, which is selected from a pyrolytic graphite sheet or a non-woven carbon fabric;
and a catalytic ink dispersed on the gas diffusion layer.

In a preferred embodiment, the metal mesh that is part of the positive electrode is selected from a nickel mesh and a steel mesh.

The catalytic ink of the positive electrode comprises:
a catalyst that comprises at least one metal oxide selected from ruthenium oxide RuO₂, manganese oxide MnO₂, iridium oxide IrO₂, nickel oxide Ni₂O₃ and lanthanum oxide La₂O₃;
a support for the catalyst based on reduced graphene oxide;
and an alcoholic solution;

In a preferred embodiment, the catalyst that is part of the catalytic ink of the positive electrode (3) comprises manganese oxide (MnO₂) and at least one metal oxide selected from ruthenium oxide RuO₂, iridium oxide IrO₂, nickel oxide Ni₂O₃ and lanthanum oxide La₂O₃.

In the most preferred embodiment, the catalyst that is part of the catalytic ink of the positive electrode (3) is manganese oxide (MnO₂).

In another preferred embodiment of the present invention, the support for the catalyst that is part of the catalytic ink of the positive electrode (3) is composed of reduced graphene oxide nanoparticles.

The use of reduced graphene oxide nanoparticles in powder form for the support confers better mechanical properties and chemical resistance to the catalytic ink; it improves the dispersion of the catalyst by increasing the active surface area and the electrical conductivity in the catalytic ink.

The manganese oxide (MnO₂) crystals are reduced on the surface of the graphene nanoparticle powder, to produce structures with a large catalyst surface area, a broad dispersion of the active points and higher electrical conductivity.

In another preferred embodiment of the electrochemical cell, the alcoholic solution that is part of the catalytic ink of the positive electrode (3) is an isopropanol aqueous solution in a 3:1 ratio.

Another preferred embodiment of the electrochemical cell of the invention relates to the fact that the first and the second positive electrodes have the same composition.

In the electrochemical cell of the present invention, a first separation membrane separates the first positive electrode from the negative electrode, and a second separation membrane separates the second positive electrode from the negative electrode. Such separation membranes have a pore size ranging between 60 and 90 pm, in order to allow for passage of the Al+³ ions, and are preferably made of polyethylene or polytetrafluoroethylene.

In another preferred embodiment of the electrochemical cell of the invention, the negative electrode that forms the anode is selected from high-purity aluminum (5N) and a high-purity aluminum alloy (5N) that comprises at least one metal selected from Mg, Sn, Zn, In and Ga.

In a more preferred embodiment, it is an aluminum alloy that comprises at least one metal selected from Mg, Sn, Zn, In and Ga, wherein the weight percentage of the metal ranges between 0.1% and 2% with respect to the total weight of the aluminum alloy.

The secondary electrochemical cell of the present invention comprises a non-aqueous electrolyte that covers the first positive electrode, the second positive electrode, the negative electrode, the first separation membrane and the second separation membrane.

In a preferred embodiment of the present invention, the non-aqueous electrolyte comprises:
an ionic liquid selected from an imidazolium salt, a pyrrolodinium salt, a phosphonium salt or a combination thereof;
an organic solvent selected from propylene carbonate, dimethyl carbonate, tetrahydrofuran, acetonitrile or a combination thereof;
and an aluminum salt selected from aluminum hexafluorophosphate, aluminum chloride, aluminum nitrate, aluminum isopropylate or a combination thereof.

In a more preferred embodiment of the present invention, the non-aqueous electrolyte comprises an imidazolium salt as the ionic liquid.

In another, more preferred embodiment, the organic solvent is selected from propylene carbonate, dimethyl carbonate or a combination thereof.

In another preferred embodiment, the weight percentage of the organic solvent in the electrolyte ranges between 0.1% and 8% with respect to the total weight of the electrolyte.

In another preferred embodiment, the aluminum salt is aluminum nitrate.

In another preferred embodiment, the weight percentage of the aluminum salt in the electrolyte ranges between 1% and 5% with respect to the total weight of the electrolyte.

The present invention offers a number of advantages as compared to current storage technologies:
It uses aluminum as the negative electrode, a metal that is very abundant, widely developed in industry, lightweight and inexpensive.
Lower weight of the electrochemical cell for the same quantity of accumulated energy.
Lower volume of the electrochemical cell for the same quantity of accumulated energy.
The materials used are non-toxic and inert in the event of spillage.
Absence of the memory effect caused by crystallisation of the components. Unlike Ni-Cd or Ni-MHx batteries, wherein charge of the battery following partial discharge led to secondary crytallisation reactions of the electrolyte salts and the loss of cell capacity, this process does not take place in the present invention.
Absence of electrolyte stratification, unlike lead-acid batteries, wherein, due to the passage of time without any usage and the effect of gravity, strata with different acid concentrations are created in the electrolyte, leading to malfunction of the electrodes.
The use of an ionic liquid as the electrolyte prevents the risk of battery ignition, which is a risk reduction factor during exposure to high temperatures.
Supply of the materials that are part of the electrodes is simple and universal. Materials that are well-known in classic industry and have a stable cost in the market.
Well-known processes for recycling and/or reusing the components that constitute the cell in the case of aluminum, pyrolytic graphite, non-woven carbon fabric and the salts that compose the electrolyte. Once the battery is exhausted, the residual materials thereof may be recycled to a high extent: on the one hand, in the presence of water, aluminum superoxide forms aluminum hydroxide, from which metallic aluminum may be obtained once again through the Hall-Herault industrial reaction. The salts that make up the electrolyte are decomposed to produce new precursor materials, and the carbon undergoes combustion, thereby becoming a heat source.

Throughout the description and the claims, the word “comprises” and variants thereof are not intended to exclude other technical characteristics, additives, components or steps. For persons skilled in the art, other objects, advantages and characteristics of the invention will arise, partly from the description and partly from the implementation of the invention. The following examples and figures are provided for illustrative purposes, and are not intended to limit the scope of the present invention.

### BRIEF DESCRIPTION OF THE FIGURES

FIG. 1 Diagram of the rechargeable aluminum-air electrochemical cell.

FIG. 2 Diagram of a positive electrode of the rechargeable aluminum-air cell.

FIG. 3 Cycling of the rechargeable aluminum-air battery at a symmetrical charge/discharge current of C/100 A.

### EXAMPLES

Below we will illustrate the invention by means of assays performed by the inventors, which demonstrate the effectiveness of the product of the invention.

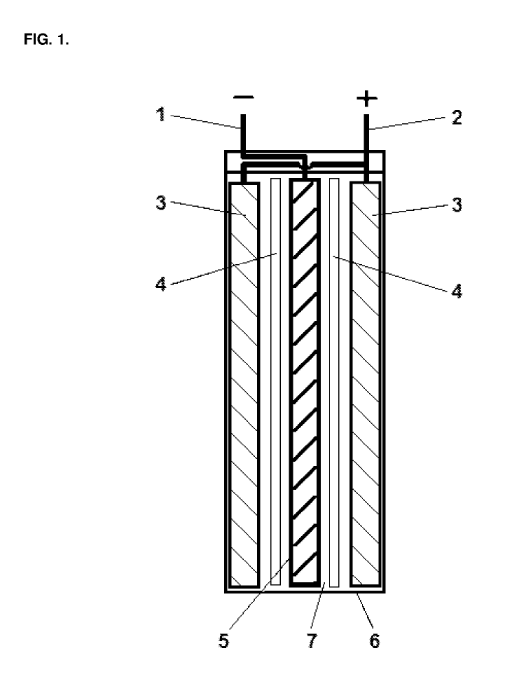

FIG. 1 shows a diagram of the composition of the rechargeable Al-air electrochemical cell, which comprises the following elements:

(1) Anode formed by a negative electrode (5)

(2) Cathode formed by two positive electrodes (3)

(3) Positive electrode the composition whereof is described below

(4) Polymer membrane with a pore size ranging between 60-90 pm

(5) Negative electrode formed by a high-purity aluminum sheet (5N)

(6) Micro-perforated housing with a perforation diameter ranging between 1 and 10 μm

(7) Electrolyte composed of an ionic liquid of the imidazolium, dimethyl carbonate and aluminum nitrate families.

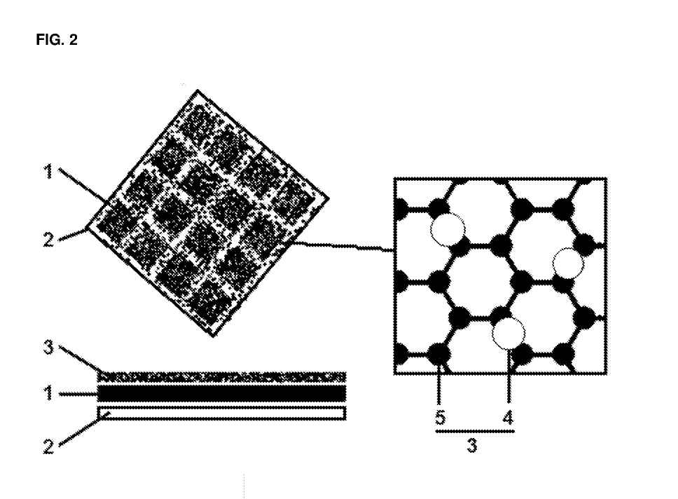

FIG. 2 shows a diagram of a positive electrode of the rechargeable Al-air cell. Said positive electrode comprises an electron-collector nickel mesh (2) and a gas diffusion layer (1) made of non-woven carbon fabric pressed into the metal mesh (2). An alcoholic catalytic ink (3) formed by reduced graphene oxide (4) and an MnO₂ catalyst (5) is dispersed on the gas diffusion layer, supported on the reduced graphene oxide (4).

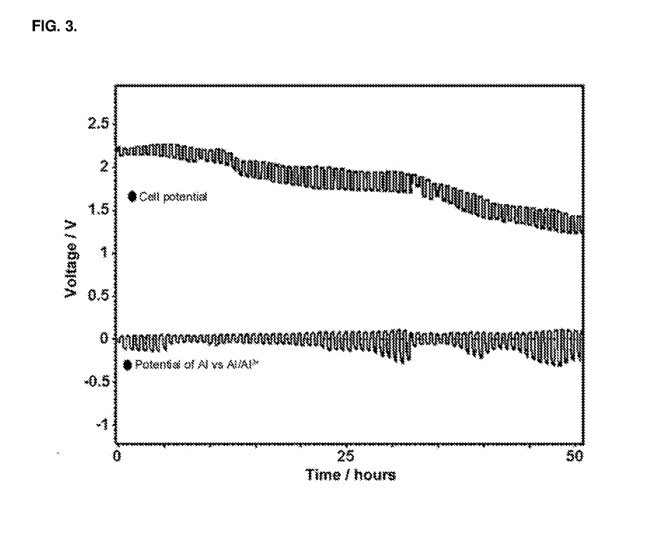

FIG. 3 shows the cycling of the rechargeable aluminum-air battery, at a charge and discharge current of C/100 A, i.e. the number of amperes per 100 hours.

The battery potential starts at 2 volts and, during the first cycles, the solid electrode-electrolyte interphase is formed, wherein the electrolyte undergoes a half-reaction with the surface of the carbonaceous electrodes to form the so-called SEI (solid electrolyte interphase). During this process, part of the electrolyte is absorbed by the carbon. From this point onward, the battery potential becomes stabilised at about 1.5 V. The cycling of the cell remains stable for at least 200 cycles, with a coulombic efficiency greater than 75%.

1. Secondary aluminum-air electrochemical cell comprising:
a first positive electrode (3) and a second positive electrode (3) electrically connected to one another, to form the cathode (2);
a negative electrode (5) that forms the anode (1), placed between the first positive electrode (3) and the second positive electrode (3);
a first separation membrane (4) placed between the first positive electrode (3) and the negative electrode (5);
a second separation membrane (4) placed between the second positive electrode (3) and the negative electrode (5);
a non-aqueous electrolyte (7) that covers the first positive electrode (3), the second positive electrode (3), the negative electrode (5), the first separation membrane (4) and the second separation membrane (4);
a micro-perforated housing (6) that comprises the first positive electrode (3), the second positive electrode (3), the negative electrode (5), the first separation membrane (4), the second separation membrane (4) and the electrolyte (7);
where each positive electrode (3) comprises:
a metal mesh;
a gas diffusion layer, pressed into the metal mesh, selected from a pyrolytic graphite sheet or a non-woven carbon fabric;
and a catalytic ink dispersed on the gas diffusion layer, wherein the catalytic ink comprises:
a catalyst that comprises at least one metal oxide selected from ruthenium oxide RuO₂, manganese oxide MnO₂, iridium oxide IrO₂, nickel oxide Ni₂O₃ and lanthanum oxide La₂O₃;
a support for the catalyst based on reduced graphene oxide;
and an alcoholic solution;
where each separation membrane (4) has a pore size ranging between 60 and 90 pm, where the negative electrode (5) comprises aluminum.

2. Secondary electrochemical cell according to claim 1, wherein the metal mesh that is part of the positive electrode (3) is selected from a nickel mesh and a steel mesh.

3. Secondary aluminum-air electrochemical cell according to claim 1, wherein the catalyst that is part of the catalytic ink of the positive electrode (3) comprises manganese oxide (MnO₂) and at least one metal oxide selected from ruthenium oxide RuO₂, iridium oxide IrO₂, nickel oxide Ni₂O₃ and lanthanum oxide La₂O₃.

4. Secondary aluminum-air electrochemical cell according to claim 3, wherein the catalyst that is part of the catalytic ink of the positive electrode (3) is manganese oxide (MnO₂).

5. Secondary aluminum-air electrochemical cell according to claim 1, wherein the support for the catalyst that is part of the catalytic ink of the positive electrode (3) is composed of reduced graphene oxide nanoparticles.

6. Secondary aluminum-air electrochemical cell according to claim 1, wherein the alcoholic solution that is part of the catalytic ink of the positive electrode (3) is an isopropanol aqueous solution in a 3:1 ratio.

7. Secondary aluminum-air electrochemical cell according to claim 1, wherein the first and the second positive electrodes (3) have the same composition.

8. Secondary aluminum-air electrochemical cell according to claim 1, wherein the separation membrane (4) has a pore size ranging between 60 and 90 pm.

9. Secondary aluminum-air electrochemical cell according to claim 1, wherein the separation membrane (4) is made of polyethylene or polytetrafluoroethylene.

10. Secondary aluminum-air electrochemical cell according to claim 1, wherein the negative electrode (5) is selected from aluminum and an aluminum alloy that comprises at least one metal selected from Mg, Sn, Zn, In and Ga.

11. Secondary aluminum-air electrochemical cell according to claim 10, wherein the negative electrode (5) is an aluminum alloy that comprises at least one metal selected from Mg, Sn, Zn, In and Ga, and the weight percentage of the metal ranges between 0.1% and 2% with respect to the total weight of the aluminum alloy.

12. Secondary aluminum-air electrochemical cell according to claim 1, wherein the non-aqueous electrolyte comprises:
an ionic liquid selected from an imidazolium salt, a pyrrolodinium salt, a phosphonium salt or a combination thereof;
an organic solvent selected from propylene carbonate, dimethyl carbonate, tetrahydrofuran, acetonitrile or a combination thereof;
and an aluminum salt selected from aluminum hexafluorophosphate, aluminum chloride, aluminum nitrate, aluminum isopropylate or a combination thereof.

13. Secondary aluminum-air electrochemical cell according to claim 12, wherein the non-aqueous electrolyte comprises an imidazolium salt as the ionic liquid.

14. Secondary aluminum-air electrochemical cell according to claim 12, wherein the organic solvent is selected from propylene carbonate, dimethyl carbonate or a combination thereof.

15. Secondary aluminum-air electrochemical cell according to claim 12, wherein the weight percentage of the organic solvent in the electrolyte ranges between 0.1% and 8% with respect to the total weight of the electrolyte.

16. Secondary aluminum-air electrochemical cell according to claim 12, wherein the aluminum salt is aluminum nitrate.

17. Secondary aluminum-air electrochemical cell according to claim 12, wherein the weight percentage of the aluminum salt in the electrolyte ranges between 1% and 5% with respect to the total weight of the electrolyte.
